(19) United States
(12) Patent Application Publication
(10) Pub. No.: US 2026/0103144 A1
(43) Pub. Date: Apr. 16, 2026

(54) CONTROL OF THE ILLUMINATION OF A PLURALITY OF OPERATING ELEMENTS OF A MOTOR VEHICLE

(71) Applicant: Ford Global Technologies, LLC, Dearborn, MI (US)

(72) Inventors: Markus Espig, Aachen (DE); David Van Bebber, Aachen (DE); Hans Guenter Quix, Herzogenrath (DE)

(73) Assignee: Ford Global Technologies, LLC, Dearborn, MI (US)

(21) Appl. No.: 19/339,410

(22) Filed: Sep. 25, 2025

(30) Foreign Application Priority Data
Oct. 15, 2024 (DE) 102024129930.4

(51) Int. Cl. B60Q 3/18; B60K 35/10; H05B 47/105; H05B 47/155; H05B 47/165

(52) U.S. Cl. CPC B60Q 3/18; B60K 35/10; H05B 47/105; H05B 47/155; H05B 47/165; B60K 2360/345; B60K 2360/349

(57) ABSTRACT

A method for controlling the illumination of a plurality of illuminable operating elements of a motor vehicle, wherein the illumination of the individual operating elements are controllable. The method comprises the steps of recording parameters which characterize at least one current operational condition of the motor vehicle based on the recorded parameters, determining a subset of the plurality of illuminable operating elements whose use is intended for the at least one current operational condition, controlling illumination of the plurality of illuminable operating elements such that the determined subset of the plurality of illuminable operating elements is visually prominent compared to the other illuminable operating elements.

### CROSS-REFERENCE TO RELATED APPLICATION

This application claims foreign priority benefits under 35 U.S. C. § 119(a)-(d) to German Application No. 102024129930.4 filed Oct. 15, 2024, which is hereby incorporated by reference in its entirety.

### FIELD OF THE DISCLOSURE

The present disclosure generally relates to a method for controlling the illumination of a plurality of illuminable operating elements of a motor vehicle, and more particularly relates to a control apparatus for controlling the illumination of a plurality of illuminable operating elements of a motor vehicle, an operating facility of a motor vehicle and a motor vehicle.

### BACKGROUND OF THE DISCLOSURE

Nowadays, motor vehicles, especially passenger cars, usually have multiple systems, features and functions that may be controlled or adjusted by the driver while driving. Examples include radio, navigation system, lane departure assist system, cruise control, air conditioning, seat heating, fan, etc. A multiplicity of operating elements are usually arranged in the region of the central console and in the region of the steering wheel. It would be desirable to provide control elements or operating elements such as buttons, control knobs, switches or controllers to be conveniently available.

### SUMMARY OF THE DISCLOSURE

According to a first aspect of the present disclosure, a method for controlling illumination of a plurality of illuminable operating elements of a motor vehicle wherein the illumination of the individual operating elements can be controlled include the steps of recording parameters which characterize at least one current operational condition of the motor vehicle, based on the recorded parameters, determining a subset of the plurality of illuminable operating elements whose use is intended for the at least one current operational condition, and controlling the illumination of the plurality of illuminable operating elements such that the determined subset of the plurality of illuminable operating elements is visually prominent compared to the other illuminable operating elements.

Embodiments of the first aspect of the present disclosure can include any one or a combination of the following features:
based on the recorded parameters, a check is performed as to whether at least one specific status from a plurality of predetermined status categories is present, wherein each status is assigned a specific subset of the plurality of illuminable operating elements, and, if a specific status is present, the subset assigned to this status is controlled at the illuminable operating elements such that it is visually prominent compared to the other operating elements;
if a specific status is no longer present, the visually highlighted illumination of the subset of the plurality of illuminable operating elements assigned to the status is reset;
the recorded parameters can be features of at least one of the motor vehicle and vehicle environment;
the recorded parameters comprise at least one of outside temperature of the motor vehicle, inside temperature of the motor vehicle, vehicle speed, a type of road currently being driven on, distance to a vehicle in front, and time and/or duration since the motor vehicle started, and at least one variable characterizing an operational state of the motor vehicle;
the recorded parameters which characterize at least one current operational condition of the motor vehicle are recorded by use of at least one of a sensor, a navigation facility, and a facility for identifying traffic signs;
at least one current operational condition of the motor vehicle is evaluated with regard to operational functions and driver assist functions which are provided for the at least one current operational condition.
the evaluation of the current operational condition of the motor vehicle with regard to the at least one of operational functions and driver assist functions by use of a self-learning algorithm takes into account at least one of specific and individual user preferences;
at least one of brightness, color and flashing behavior of the illuminable operating elements is controlled; and
the method is executed by a computer.

According to a second aspect of the present disclosure, a control apparatus for controlling illumination of a plurality of illuminable operating elements of a motor vehicle wherein the illumination of individual operating elements are controllable includes a facility for receiving recorded parameters, which characterize at least one current operational condition of the motor vehicle. The control apparatus is configured to perform a method to control illumination of the individual operating elements comprising the steps of recording parameters which characterize at least one current operational condition of the motor vehicle, based on the recorded parameters, determining a subset of the plurality of illuminable operating elements whose use is intended for the at least one current operational condition, and controlling the illumination of the plurality of illuminable operating elements such that the determined subset of the plurality of illuminable operating elements is visually prominent compared to the other illuminable operating elements.

Embodiments of the second aspect of the present disclosure can include any one or a combination of the following features:
the plurality of illuminable operating elements are located in an operating facility of the motor vehicle; and
based on the recorded parameters, the method comprises a check performed as to whether at least one specific status from a plurality of predetermined status categories is present, wherein each status is assigned a specific subset of the plurality of illuminable operating elements, and, if a specific status is present, the subset assigned to this status is controlled at the illuminable operating elements such that it is visually prominent compared to the other operating elements.

According to a third aspect of the present disclosure, a motor vehicle includes an operating facility, a plurality of illuminable operating elements in the operating facility, and a control apparatus for controlling illumination of the plurality of illuminable operating elements, wherein the illumination of individual operating elements are controllable. The control apparatus is configured to perform a method comprising the steps of recording parameters which characterize at least one current operational condition of the motor vehicle, based on the recorded parameters, determining a subset of the plurality of illuminable operating elements whose use is intended for the at least one current operational condition, and controlling the illumination of the plurality of illuminable operating elements such that the determined subset of the plurality of illuminable operating elements is visually prominent compared to the other illuminable operating elements.

Embodiments of the second aspect of the present disclosure can include any one or a combination of the following features:
based on the recorded parameters, a check is performed as to whether at least one specific status from a plurality of predetermined status categories is present, wherein each status is assigned a specific subset of the plurality of illuminable operating elements, and, if a specific status is present, the subset assigned to this status is controlled at the illuminable operating elements such that it is visually prominent compared to the other operating elements; and
if a specific status is no longer present, the visually highlighted illumination of the subset of the plurality of illuminable operating elements assigned to the status is reset.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a flow diagram showing one embodiment of a method in accordance with one example;

FIG. 2 is a flow diagram showing a further embodiment of a method in accordance with another example;

FIG. 3 is a schematic diagram of a steering wheel and a central console of a motor vehicle with an operating facility in accordance with one example of the method;

FIG. 4 is a schematic diagram of a steering wheel and a central console of a motor vehicle with an operating facility in accordance with one example of the method;

FIG. 5 is a schematic diagram of a steering wheel and a central console of a motor vehicle with an operating facility in accordance with one example of the method;

FIG. 6 is a schematic diagram of a steering wheel and a central console of a motor vehicle with an operating facility in accordance with one example of the method;

FIG. 7 is a schematic diagram of a steering wheel and a central console of a motor vehicle with an operating facility in accordance with one example of the method; and

FIG. 8 is a schematic sideview of a motor vehicle further illustrating the operating facility.

### DETAILED DESCRIPTION OF PREFERRED EMBODIMENTS

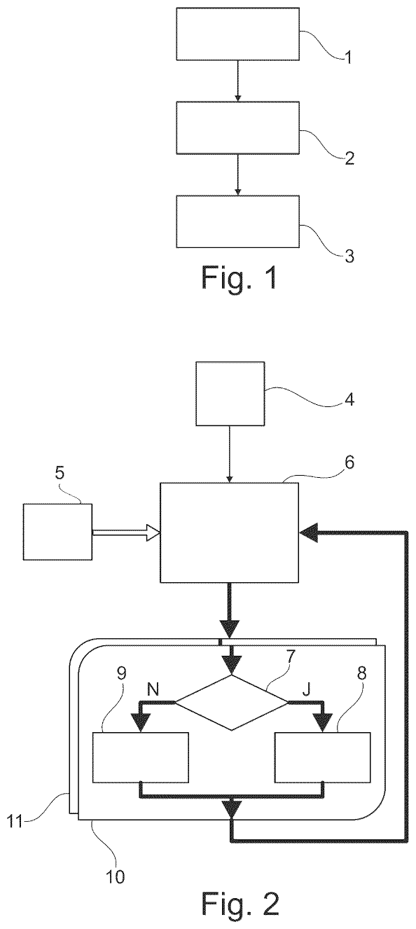

FIG. 1 shows schematically a method for controlling the illumination of a plurality of illuminable operating elements of a motor vehicle in the form of a flow diagram. The illumination of the individual operating elements can be controlled. The illumination of the individual operating elements can be controlled individually or groups of multiple operating elements can be controlled at the same time. In step 1, a number, preferably a plurality, of parameters is recorded. The parameters characterize at least one current operational condition of the motor vehicle. Examples of parameters which can be recorded are the ambient temperature, the passenger compartment temperature, type of road, state of the road, recognized traffic signs, speed of the motor vehicle, time since the start of the motor vehicle, distance to a vehicle in front, etc. The parameters can be recorded by use of sensors and/or navigation facilities.

In step 2, based on the recorded parameters, a subset of the plurality of illuminable operating elements whose use is intended for the at least one current operational condition is determined. Subsequently, in step 3, the illumination of the plurality of illuminable operating elements is controlled in such a manner that the determined subset of the plurality of illuminable operating elements is visually prominent compared to the other operating elements. The brightness and/or the color and/or the flashing behavior of the illuminable operating elements can be appropriately changed or adapted. In other words, at least one of the brightness, color and flashing behavior of the illuminable operating elements can be changed or adapted.

FIG. 2 shows schematically a further variant of a method in accordance with the disclosure in the form of a flow diagram. The method is started in step 4. In step 5, as in the FIG. 1 in step 1, parameters are recorded which characterize at least one current operational condition of the motor vehicle. In step 6, the recorded parameters are imported or received by a control apparatus. The blocks 10 and 11 characterize by way of example two of a plurality of classified operational conditions or status, for which in each case use of specific functions is intended which can be controlled by a specific subset of the plurality of illuminable operating elements. In other words, each status is assigned a specific subset of the plurality of illuminable operating elements.

In step 7, a check is performed for each of the classified operational conditions or status 10, 11 as to whether they are present. If this is the case, a highlighted illumination of the illuminable operating elements designated for the respective status or the respective operational condition is switched on in step 8. If the respective status or the respective operational condition is not present, a highlighted illumination of the illuminable operating elements designated for the respective status or the respective operational condition is switched off or respectively a corresponding illumination is reset or deleted. Following on from steps 8 and 9, the method jumps back to step 6.

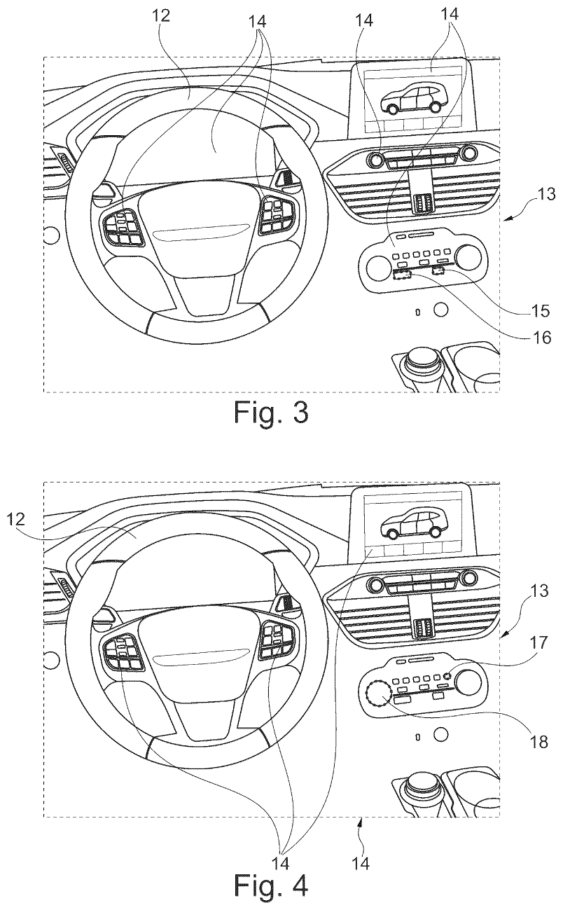

FIGS. 3 to 7 show schematically a steering wheel 12 and a central console 13 of a motor vehicle with an operating facility 14 in accordance with the disclosure which records a plurality of illuminable operating elements in different embodiment variants of the method in accordance with the disclosure. The individual operating elements in a standard passenger car are the usual operating elements in the form of buttons, rotary switches or touch switches, knobs, screens, etc. which are not all characterized by reference characters.

In the example shown in FIG. 3, it is recorded that the passenger compartment temperature is below 18 degrees Celsius and that the time elapsed since the start of the motor vehicle is less than 5 minutes. This corresponds in the present case to an operational state or status of the motor vehicle for which the use of seat heating and steering wheel heating is intended. In accordance with the disclosure, the button for controlling the seat heating 15 and the button for controlling the steering wheel heating 16 is illuminated in such a manner that these buttons are visually prominent. The brightness of the illumination of these buttons can be increased or the brightness of the illumination of the other buttons can be reduced or the color of the illumination of the buttons changed or the buttons 15 and 16 illuminated in a flashing manner.

In the example shown in FIG. 4, it is recorded that the passenger compartment temperature is above 24 degrees Celsius. This corresponds in the present case to an operational state or status of the motor vehicle for which it is intended to use an air conditioning system (A/C) and to control the temperature. In accordance with the disclosure, the button for controlling the air conditioning system 17 and the button for controlling the temperature 18 are illuminated in such a manner that these buttons are visually prominent, for example, by adjusting the brightness and/or color and/or flashing status.

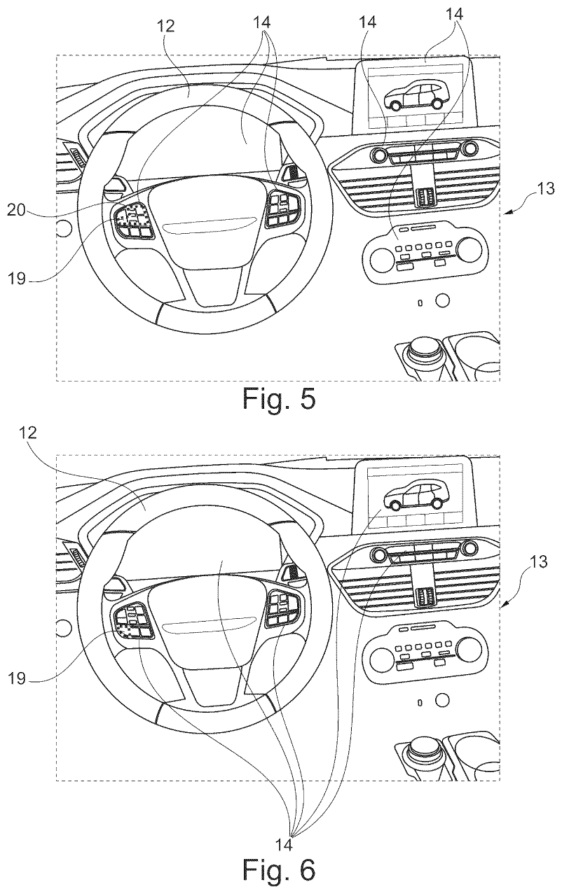

In the example shown in FIG. 5, it has been recorded that the speed of the motor vehicle has been above 100 km/h for at least 2 minutes or that the motor vehicle is on a highway. In this case, this corresponds to an operational state or status of the motor vehicle for which the use of adaptive cruise control (ACC) and lane departure assist system is intended. In accordance with the disclosure, the buttons for automatically controlling the speed (ACC) 20 and the buttons for controlling the lane departure assist system 19 are illuminated in such a manner that these buttons are visually prominent, for example, by adjusting the brightness and/or color and/or flashing status.

In the example shown in FIG. 6, it is recorded by use of the navigation facility, for example, that the motor vehicle is driven off a highway or that the motor vehicle is approaching a construction site or a traffic sign has been recognized, which indicates a construction site or other roadway condition. In the present case, this corresponds to at least one operational state or status of the motor vehicle for which it is recommended to deactivate a lane departure assist system. In accordance with the disclosure, the button for deactivating the lane departure assist system 19 is therefore illuminated in such a manner that this button is visually prominent, for example, by adjusting the brightness and/or color and/or flashing status.

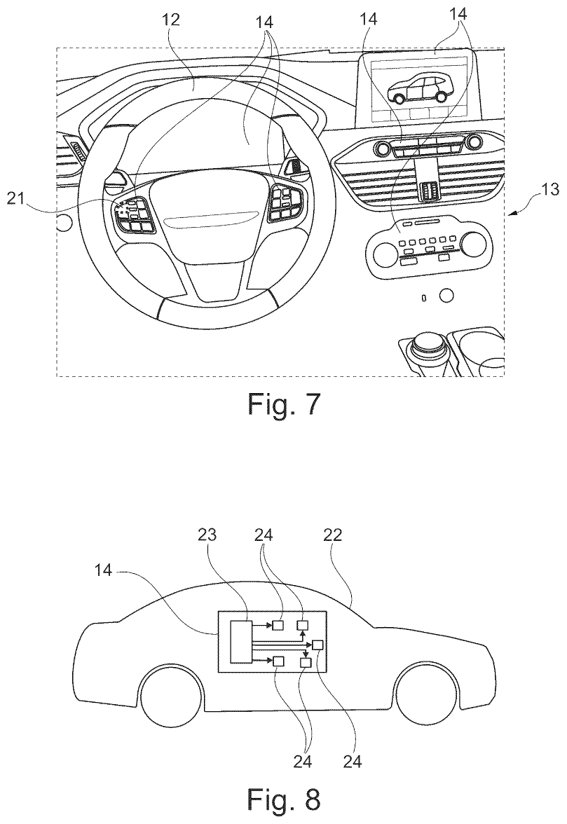

In the example shown in FIG. 7, it is recorded that the adaptive cruise control (ACC) is activated. This corresponds in the present case to an operational state or status of the motor vehicle for which the use of adaptive cruise control or an automated distance control (ACC) is intended. The operational state can be defined so that it is always present when adapted cruise control is activated, or only for a specified period after adapted cruise control is activated or after the accelerator pedal is used to override an ACC speed entry. In accordance with the disclosure, the button for activating the adaptive cruise control or an automated distance control (ACC) 21 is illuminated in such a manner that this button is visually prominent, for example, by adjusting the brightness and/or color and/or flashing status.

FIG. 8 shows schematically a motor vehicle 22 in accordance with the disclosure. The motor vehicle 22 comprises an illuminating facility 14 which comprises a plurality of illuminable operating elements 24, which can be inter alia the operating elements 15-21 of the FIGS. 3 to 7, and a control apparatus 23. The control apparatus 23 may be configured as a microprocessor or other control circuitry and is configured so as to perform a method in accordance with the disclosure for controlling the illumination of the operating elements 24, by way of example a method described with the aid of FIGS. 1 to 7.

The present disclosure provides an advantageous method for controlling the illumination of a plurality of illuminable operating elements in a motor vehicle, and provides an advantageous control apparatus for controlling the illumination of a plurality of illuminable operating elements of a motor vehicle, an advantageous operating facility of a motor vehicle and an advantageous motor vehicle, as well as an advantageous computer-implemented method, a computer program product, a computer-readable data carrier and a data carrier signal.

The method in accordance with the disclosure for controlling the illumination of a plurality of illuminable operating elements of a motor vehicle, wherein the illumination of the individual operating elements can be controlled, for example individually or in specified groups, comprises the following steps: In a first step, a number, preferably a plurality, of parameters are recorded which characterize or in other words define at least a current operational condition of the motor vehicle. The term “parameter” is understood to mean a recordable, in particular measurable, variable of a property of the vehicle and/or of the vehicle environment. The current operational condition of the motor vehicle may include, for example, the current driving situation or operational situation or traffic situation or current weather conditions or road conditions.

In a second step, based on the recorded parameters, a subset of the plurality of illuminable operating elements whose use is intended for the at least one current operational condition is determined. In other words, the illuminable operating elements are therefore determined whose use is probable under the current operational conditions or can be expected with a predetermined probability or whose use is recommended or which are assigned to the current driving situation or operational situation or traffic situation derived from the recorded parameters. The recorded parameters are evaluated with respect to required and/or recommended control variables or operating variables and operating elements assigned to them.

In a third step, the illumination of the plurality of illuminable operating elements is controlled in such a manner that the determined subset of the plurality of illuminable operating elements is visually prominent compared to the other operating elements.

The operating elements can be designed as a human machine interface (HMI) or control panels or control knobs or controllers or switches or wheels or levers or buttons or touchscreens.

Examples of driving situation-dependent functions or operating elements are: highlighted display of an operating element for seat heating and/or of an operating element for steering wheel heating at the start of a journey when outside temperatures are low; highlighted display of an operating element for air conditioning and temperature control when outside temperatures and/or passenger compartment temperatures are high; highlighted display of an operating element for cruise control and/or adaptive cruise control and/or a lane departure assist system after entering a highway; highlighted display of an operating element for deactivating a lane departure assist system when approaching a construction site; highlighted display of an operating element for adaptive cruise control when driving with cruise control activated, for example, always or only for a specified period of time since cruise control was activated or after pressing the accelerator pedal to override the speed setting, etc.

The method in accordance with the disclosure has the advantage that it makes it considerably easier for a user to find the required operating elements in a specific driving situation, i.e., in particular in a specific traffic situation or weather situations or road situations. In particular, the required time for searching for the correct operating element may be reduced. It enables more relaxed driving and increases driving comfort. Furthermore, the overall illuminating intensity of the vehicle interior can be reduced, as only the relevant controls can be illuminated.

In an advantageous variant, the recorded parameters are used to check whether at least one specific status, for example, a current operational state and/or a current traffic situation, is currently present from a plurality of specified, for example, predetermined or defined, status categories, whereby each status is assigned a specific subset of the plurality of illuminable operating elements. If a specific status is present, the subset of illuminable operating elements assigned to this status is controlled in such a manner that it is visually prominent compared to the other operating elements. If a specific status is no longer present, the visually highlighted illumination of the subset of the plurality of illuminable operating elements assigned to the status can be reset. The described categorization has the advantage that specified groups of operating elements can be controlled at the same time with respect to their illumination. This can reduce the complexity of the control system and its efficiency.

The recorded parameters can be in general features of the motor vehicle and/or of the vehicle environment. For example, the recorded parameters may include the outside temperature of the motor vehicle and/or the inside temperature of the motor vehicle, i.e., the passenger compartment temperature, and/or the vehicle speed and/or the type of road currently being driven on, for example, highway, expressway, country road, road within a town, construction site, etc., and/or the distance to a vehicle in front and/or the time and/or the duration since the motor vehicle started and/or at least one variable characterizing the operational state of the motor vehicle.

The parameters, in particular those of the vehicle and/or the vehicle environment, which characterize at least one current operational condition of the motor vehicle, can be recorded by use of a sensor and/or a navigation facility and/or a device for recognizing traffic signs, for example a camera and an image recognition device. The variants mentioned render it possible to record the required parameters in a reliable manner.

In a further variant, at least one current operational condition of the motor vehicle can be evaluated or analyzed in relation to operational functions and/or driver assistance functions which are provided for the at least one current operational condition or are normally used under the at least one current operational condition. The current operational condition of the motor vehicle can be evaluated with regard to operational functions and/or driver assist functions by use of a self-learning, in particular in particular in part self-learning, algorithm which takes into account specific and/or individual user preferences. This variant has the advantage that it can be adapted individually to an individual user or user groups.

Advantageously, it is possible to control the brightness and/or the color and/or the flashing behavior of the illuminable operating elements. For example, the determined subset of the plurality of illuminable operating elements can be illuminated brighter than the other operating elements. In particular, the brightness of the determined subset of the plurality of illuminable operating elements can be increased and/or the brightness of the other operating elements can be reduced. In addition or as an alternative, the determined subset of the plurality of illuminable operating elements can be illuminated with a different color, i.e., a different color than the other operating elements. In a further additional or alternative variant, the determined subset of the plurality of illuminable operating elements can be illuminated in a flashing manner, while the other operating elements are not illuminated in a flashing manner. The mentioned variants enable a user to quickly and reliably locate the operating elements required in specific operational situations.

The control apparatus in accordance with the disclosure for controlling the illumination of a plurality of illuminable operating elements of a motor vehicle, wherein the illumination of the individual operating elements, for example, individually or in specified groups, is controllable, wherein the control apparatus comprises a device for receiving recorded parameters, in particular parameters of the vehicle and/or the vehicle environment, which characterize at least one current operational condition of the motor vehicle, and is designed to carry out a previously described method in accordance with the disclosure. The control apparatus in accordance with the disclosure has the features and advantages described in connection with the method.

The operating facility of a motor vehicle comprises a plurality of illuminable operating elements. The illumination of the individual operating elements can be controlled, for example individually or in specified groups. The operating facility comprises a previously described control apparatus in accordance with the disclosure. The operating facility in accordance with the disclosure has the already mentioned features and advantages.

The motor vehicle in accordance with the disclosure comprises a previously described operating facility. It has the advantages already described. The motor vehicle may be a passenger car, truck, bus, minibus, motorcycle or moped, for example.

The computer-implemented method in accordance with the disclosure comprises commands that, when the program is executed by a computer, cause the computer to perform the method in accordance with the disclosure described above. The computer program product comprises commands that, when the program is executed by a computer, cause the computer to perform the method in accordance with the disclosure described above. The computer program product is stored on the computer-readable data carrier in accordance with the disclosure. The data carrier signal transmits the computer program product in accordance with the disclosure. The computer-implemented method, the computer program product, the computer-readable data carrier and the data carrier signal have the features and advantages already mentioned above.

The disclosure is described in detail below with the aid of exemplary embodiments with reference to the attached figures. Although the method, vehicle and control apparatus are further illustrated and described in detail according to exemplary embodiments, the disclosure is not limited by the disclosed examples and other variations may be derived therefrom by a person skilled in the art without abandoning the protective scope of the disclosure.

The figures are not necessarily accurate in every detail or true-to-scale and may be illustrated enlarged or reduced in size in order to offer a better overview. The functional details disclosed here are therefore not to be understood as limiting but rather merely as an illustrative basis for offering a person skilled in the art in this field of technology an instruction in order to use the present disclosure in numerous ways.

The expression “and/or” used here, when it is used in a series of two or more elements, means that each of the listed elements can be used alone or any combination of two or more of the listed elements can be used. If, for example, a composition is described which contains the components A, B and/or C, the composition can contain A alone; B alone; C alone; A and B in combination; A and C in combination; B and C in combination; or A, B, and C in combination.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A method for controlling illumination of a plurality of illuminable operating elements of a motor vehicle, wherein the illumination of the individual operating elements can be controlled, the method comprising the steps of:
recording parameters which characterize at least one current operational condition of the motor vehicle;
based on the recorded parameters, determining a subset of the plurality of illuminable operating elements whose use is intended for the at least one current operational condition; and
controlling the illumination of the plurality of illuminable operating elements such that the determined subset of the plurality of illuminable operating elements is visually prominent compared to the other illuminable operating elements.

2. The method as claimed in claim 1, wherein, based on the recorded parameters, a check is performed as to whether at least one specific status from a plurality of predetermined status categories is present, wherein each status is assigned a specific subset of the plurality of illuminable operating elements, and, if a specific status is present, the subset assigned to this status is controlled at the illuminable operating elements such that it is visually prominent compared to the other operating elements.

3. The method as claimed in claim 2, wherein, if a specific status is no longer present, the visually highlighted illumination of the subset of the plurality of illuminable operating elements assigned to the status is reset.

4. The method as claimed in claim 1, wherein the recorded parameters can be features of at least one of the motor vehicle and vehicle environment.

5. The method as claimed in claim 1, wherein the recorded parameters comprise at least one of outside temperature of the motor vehicle, inside temperature of the motor vehicle, vehicle speed, a type of road currently being driven on, distance to a vehicle in front, and time and/or duration since the motor vehicle started, and at least one variable characterizing an operational state of the motor vehicle.

6. The method as claimed in claim 1, wherein the recorded parameters which characterize at least one current operational condition of the motor vehicle are recorded by use of at least one of a sensor, a navigation facility, and a facility for identifying traffic signs.

7. The method as claimed in claim 1, wherein at least one current operational condition of the motor vehicle is evaluated with regard to operational functions and driver assist functions which are provided for the at least one current operational condition.

8. The method as claimed in claim 7, wherein the evaluation of the current operational condition of the motor vehicle with regard to the at least one of operational functions and driver assist functions by use of a self-learning algorithm takes into account at least one of specific and individual user preferences.

9. The method as claimed in claim 1, wherein at least one of brightness, color and flashing behavior of the illuminable operating elements is controlled.

10. The method as claimed in claim 1, wherein the method is executed by a computer.

11. A control apparatus for controlling illumination of a plurality of illuminable operating elements of a motor vehicle, wherein the illumination of individual operating elements are controllable, the control apparatus comprising:
a facility for receiving recorded parameters, which characterize at least one current operational condition of the motor vehicle, wherein the control apparatus is configured to perform a method to control illumination of the individual operating elements, the method comprising the steps of:
recording parameters which characterize at least one current operational condition of the motor vehicle;
based on the recorded parameters, determining a subset of the plurality of illuminable operating elements whose use is intended for the at least one current operational condition; and
controlling the illumination of the plurality of illuminable operating elements such that the determined subset of the plurality of illuminable operating elements is visually prominent compared to the other illuminable operating elements.

12. The control apparatus of claim 11, wherein the plurality of illuminable operating elements are located in an operating facility of the motor vehicle.

13. The control apparatus of claim 11, wherein, based on the recorded parameters, the method comprises a check performed as to whether at least one specific status from a plurality of predetermined status categories is present, wherein each status is assigned a specific subset of the plurality of illuminable operating elements, and, if a specific status is present, the subset assigned to this status is controlled at the illuminable operating elements such that it is visually prominent compared to the other operating elements.

14. A motor vehicle comprising:
an operating facility;
a plurality of illuminable operating elements in the operating facility; and
a control apparatus for controlling illumination of the plurality of illuminable operating elements, wherein the illumination of individual operating elements are controllable, wherein the control apparatus is configured to perform a method comprising the steps of:
recording parameters which characterize at least one current operational condition of the motor vehicle;
based on the recorded parameters, determining a subset of the plurality of illuminable operating elements whose use is intended for the at least one current operational condition; and
controlling the illumination of the plurality of illuminable operating elements such that the determined subset of the plurality of illuminable operating elements is visually prominent compared to the other illuminable operating elements.

15. The motor vehicle as claimed in claim 14, wherein, based on the recorded parameters, a check is performed as to whether at least one specific status from a plurality of predetermined status categories is present, wherein each status is assigned a specific subset of the plurality of illuminable operating elements, and, if a specific status is present, the subset assigned to this status is controlled at the illuminable operating elements such that it is visually prominent compared to the other operating elements.

16. The motor vehicle as claimed in claim 15, wherein, if a specific status is no longer present, the visually highlighted illumination of the subset of the plurality of illuminable operating elements assigned to the status is reset.
